(19) United States
(12) Patent Application Publication
(10) Pub. No.: US 2006/0101513 A1
(43) Pub. Date: May 11, 2006

(54) Method for operating a microprocessor

(75) Inventors: Berndt Gammel, Markt Schwaben (DE); Steffen Marc Sonnekalb, Taufkirchen (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/221,383

(22) Filed: Sep. 6, 2005

Related U.S. Application Data
(63) Continuation of application No. PCT/DE04/00241, filed on Feb. 10, 2004.

(30) Foreign Application Priority Data
Mar. 12, 2003 (DE) 10310781.9

(51) Int. Cl. G06F 7/38

(52) U.S. Cl. 726/22; 712/233

(57) ABSTRACT

A method for operating a microprocessor in which there is at least one program branch and/or program delay which is implemented under random-bit control and as a hardware-based command in order to modulate a program flow and which ensures that every pass through a particular program brings about a respective program execution time which is different than that in preceding program passes.

### CROSS-REFERENCE TO RELATED APPLICATION

This application is a continuation of International Patent Application Serial No. PCT/DE2004/000241, filed Feb. 10, 2004, which published in German on Sep. 23, 2004 as WO 2004/081971, and is incorporated herein by reference in its entirety.

### FIELD OF THE INVENTION

The present invention relates to a method for operating a microprocessor and to a microprocessor arrangement.

### BACKGROUND OF THE INVENTION

In programs in security applications which are programmed on a microprocessor, it is generally possible to spy out secret information, such as keys, by evaluating command sequences.

There are various possible ways of attacking such circuits for security applications. In the case of “Side Channel Attacks”, for example, the circuit's drawn current or electromagnetic emission is recorded when a particular process takes place in the circuit. From the timing, particularly the time reference, for the drawn current or for the electromagnetic emission it is possible to infer the key which is being used, for example.

Differential power analysis (DPA) is a known attack scenario for security CPUs. In the case of such an attack, a sequence of commands in a program and their effects in the circuit are ascertained using statistical evaluations of the characteristic curves of the power consumption. From these evaluations it is possible to obtain detailed conclusions about the program which is being executed. The recording of the electromagnetic emission is known by the name DEMA (“Differential Electro-Magnetic Analysis”).

Programs always have a plurality of program or code sequences which are independent of one another and whose order in the execution can be switched. To protect against the type of attacks mentioned above, the program flow has to date been changed by means of software and a random control. In this context, by way of example, command sequences have been switched by permutation, redundant command sequences have been inserted or a plurality of different code sequences giving the same result have been introduced. However, this requires the use of a random number generator, which generates undeterminable random bits which are evaluated by means of software at appropriate branch points within the program in order to branch to the appropriate code sequence upon a jump command, for example.

A further method for protecting against this type of attacks is a random-controlled program delay in which dummy code sequences whose execution time is determined using a random number generator are inserted into the running program code.

A method which is known from the published WO/9963419 describes the actuation of a “Wait State Connection” in a circuit by a random number generator, where the operation of the circuit is stopped or resumed on the basis of the number generated by the random number generator, and as a result uniform processing cycles are prevented.

A drawback of the methods mentioned above is that the program size increases, the runtime of the program is extended, the performance is reduced and increased power consumption can be recorded.

### SUMMARY OF THE INVENTION

Against the background of this prior art, the invention is based on an object of providing a method for operating a microprocessor and a microprocessor arrangement which ensure adequate security with minimum program complexity.

This object is achieved by a method and a microprocessor arrangement in which there is at least one program branch and/or program delay which is implemented under random-bit control and as a hardware-based command in order to modulate a program flow.

### DETAILED DESCRIPTION OF PREFERRED EMBODIMENTS OF THE INVENTION

Since the program flow is determined by the order of the commands and their runtime required for execution, the modulation of a program flow is advantageously controlled by virtue of, by way of example, a bit randomly generated using a pseudo-random number generator being logically combined with a generated undeterminable bit from a genuine physical random number generator to form a random bit which is used by the hardware-based commands of the microprocessor in order to execute program branches and/or program delays randomly.

Advantageously, commands are introduced which have a variable execution time by virtue of the runtime of the commands being altered randomly using the commands' associated parameters, which specify operation cycles, for example. It is likewise possible to insert commands into the program flow which execute a no-operation and have no influence on the result of a code sequence.

Random-controlled program branches are advantageously provided by jump commands with at least one jump destination. In this case, the jump is performed or not performed on the basis of the value of a random bit. In the case of a jump command with at least two jump destinations, with code sequences which can be executed independently of one another at the destination addresses, the order of the code sequences to be executed can be varied under random-bit control. The destination addresses do not imperatively all have to be executed if they achieve the same result. If these code sequences have different runtime profiles, for example, the timing to attain a result cannot be determined for a fresh program pass, which means that the previously described methods of attack provide no useful information.

The invention is explained in more detail below using exemplary embodiments.

In the first exemplary embodiment below, a jump command (“jumble”) is implemented, with the jump command specifying a jump destination:

```
Jumble <address1>
    ...
    code sequence 1
    goto address 2
  address1:
            ...
            code sequence 2
  address2:
            ...
            common code sequence
```

The value of the random bit governs whether the jump is executed or not executed. If the random bit is set, for example, that is to say has the value “1”, then the jump operation to address “address1” is executed, where the code sequence 2 is executed and then the common code sequence “common code sequence” is processed at the address “address2”. In this case, the code sequence 1 may contain a no-operation which has no influence on the result. If the random bit is not set, that is to say has the value “0”, then the jump to address “address1” is not executed, but rather the program flow continues linearly with the code sequence “code sequence 1” and the subsequent jump to address “address2”.

In the next exemplary embodiment, a jump command (“jumble”) is implemented with the jump command branching to three jump destinations:

```
Jumble <addr1>, <addr2>, <addr3>
addr1: code sequence 1
            goto addr 4
addr2: code sequence 2
            goto addr 4
addr3: code sequence 3
            goto addr 4
addr4: common code sequence
```

The order of execution of the code sequences “code sequence 1, code sequence 2 and code sequence 3” at the addresses “addr1, addr2 and addr3” for the jump destinations can be switched, since they are functionally not dependent on one another. The code sequences which are equivalent to the result that is to be attained do not imperatively all have to be executed, which means that random-bit control can be used to jump to an address at which the appropriate code sequence is executed and then the program flow is continued at the address “address4”. The fact that the code sequences have different runtime responses and each fresh program pass involves a jump to a different address means that it is not possible to analyze the data obtained by wiretapping methods. The random-bit controlled order for necessary execution of all code sequences also provides no useful data.

The following exemplary embodiment shows a jump command with two possible jump destinations which is implemented as the call command “jumblecall” and provides a change of context by virtue of a jump:

```
Jumblecall <add1>, <addr2>
...
some code
...
addr1: code sequence 1
            return
...
some code
...
addr2: code sequence 2
            return
```

In this example, random-bit control can be used to execute the command either to one or to both jump destinations. In order to exit the subprogram when a code sequence has been executed, a “return” command is executed which restores the previous context.

The following exemplary embodiment shows a command which executes a no-operation “jumplenop”:

...
jumplenop <n>, <m>
...

In this case, the random-bit controlled parameters <n> and <m> specify the upper and lower limits of possible operation cycles, so that a variable run length for the command is attained. To attain a variable execution time for a command, with the parameters being able to be associated with any command, it could also be possible to specify just one parameter as an upper limit. If the parameters have the value “0”, the command is executed in an optimum time period. If the parameters have a value which is different than “0”, up to <n> or <m> clock cycles are required in order to execute this command.

The command “jumpleadd” in the following exemplary embodiment may likewise be applied for all commands:

...
jumpleadd Rx, Ry

This command is used to extend the execution time likewise randomly.

In general, the parameters determining the runtime of a command do not imperatively have to be specified for every single command. These parameters may be stored in a configuration register which is accessed using a configuration command “jumple_config <op1> <op2>”, for example.

The previously described method relates not only to the examples presented. Rather, these are intended to illustrate that program delays and program branches can be implemented in any variation in order to modulate a program flow.

What is claimed is:

1. A method for operating a microprocessor, comprising the step of providing at least one program branch and/or program delay which is implemented under random-bit control and as a hardware-based command in the microprocessor in order to modulate a program flow.

2. The method as claimed in claim 1, further comprising the step of obtaining the program delay using hardware-based commands with a randomly varying runtime.

3. The method as claimed in claim 2, further comprising the step of determining the randomly varying runtime by random-bit controlled parameters which are associated with the commands and which stipulate the runtime of a command.

4. The method as claimed in claim 3, further comprising the step of firmly prescribing the commands' parameters determining the runtime using a configuration register associated with the microprocessor.

5. The method as claimed in claim 1, further comprising the steps of:
obtaining the at least one program branch using a hardware-based jump command with a jump destination; and
determining, using the random bit, whether or not a jump is executed.

6. The method as claimed in claim 1, further comprising the step of obtaining the at least one program branch using a hardware-based jump command with at least two jump destinations.

7. A system for operating a microprocessor, comprising:
means for providing at least one program branch and/or program delay which is implemented under random-bit control and as a hardware-based command in the microprocessor in order to modulate a program flow; and
means for obtaining the program delay using hardware-based commands with a randomly varying runtime.

8. A computer program having a program code for performing a method for operating a microprocessor, comprising the step of providing at least one program branch and/or program delay which is implemented under random-bit control and as a hardware-based command in the microprocessor in order to modulate a program flow, when the computer program runs on a computer.

9. A system for performing a method for operating a microprocessor, the system comprising:
a processor;
a memory communicatively coupled to the processor; and
software executing in the processor configured to provide at least one program branch and/or program delay which is implemented under random-bit control and as a hardware-based command in the microprocessor in order to modulate a program flow.
